(19) United States
(12) Patent Application Publication
(10) Pub. No.: US 2026/0208371 A1
(43) Pub. Date: Jul. 23, 2026

(54) LOADING, TRANSPORTING AND UNLOADING OF ARTICLES SUCH AS CARDBOARD BOXES OR CRATES

(71) Applicant: SIDEL PARTICIPATIONS, Octeville-sur-Mer (FR)

(72) Inventor: Laurent FERRE, SAINT-LAURENT-SURSEVRE (FR)

(21) Appl. No.: 19/135,933

(22) PCT Filed: Dec. 7, 2023
(86) PCT No.: PCT/EP2023/084769

§ 371 Date: Jun. 5, 2025

(30) Foreign Application Priority Data
Dec. 8, 2022 (FR) FR2212968

(51) Int. Cl. B25J 15/02; B25J 9/00; B25J 9/12; B25J 9/16; B25J 13/08; B25J 15/12

(52) U.S. Cl. CPC B25J 15/0286; B25J 9/0093; B25J 9/123; B25J 9/1687; B25J 13/082; B25J 15/12

(57) ABSTRACT

Provided is a gripping device to be mounted on a robot for a palletizing system, for loading, transporting and unloading articles of the box or crate type. The device includes a support for fastening to the robot, and a guide means mounted on the support. The device is has at least two jaws that face one another and are mounted movably on the guide means, for clasping the sides of at least one article with the support above the article. And an actuating means for moving the jaws independently of one another along the guide means between a spaced-apart position and a clasping position. Also provided is a system for loading, transporting and unloading articles, and to a process for palletizing articles.

### TECHNICAL FIELD

The present invention relates to the palletizing of articles of the cardboard box or crate type and concerns, more particularly, an improvement to the manipulator robot which takes hold of the articles, fed for example by a feed conveyor, in order to store them on a pallet.

The subject of the invention is a gripping device to be mounted on a robot, making it possible to load, to transport and then to unload one or more articles of the cardboard box or crate type, in particular to load pallets with articles to be transported which have different external dimensions and are of different types.

The invention also relates to a palletizing system having such a device and to the operating process that uses the latter.

### PRIOR ART

As is known, within a container packaging line, said containers can undergo several different successive processing operations, such as manufacturing, filling, and then closing with a closure and labeling.

For handling, such containers are packaged in batches.

First of all, the containers are grouped together, then each group can be wrapped up to form a batch, in particular covered with a film, in order to keep the containers together and to make it easier to handle such a batch obtained in this way.

The groups of containers, wrapped or not wrapped, can also be placed in cardboard boxes or crates. These cardboard boxes or crates are then moved and stacked to form layers on a pallet in order to be stored or handled.

In a packaging line, the palletizer is part of what is referred to as the end-of-line, meaning that it receives articles of the crate or cardboard box type comprising containers leaving a packaging system at a certain rate.

### TECHNICAL BACKGROUND

Palletizing systems generally comprise a structure that acts as a chassis for supporting the manipulator robot or palletizer. The gripping head of such a robot may be pivotable and be equipped with suction cups for taking hold of the articles on the feed conveyor and subsequently storing them, in the correct orientation, on the pallet.

This type of system is subject to numerous constraints associated with the type of the articles, their weight, their space requirement or with the throughput of the system. Furthermore, the palletizer needs to be versatile enough to allow the loading of articles of various formats: it needs to be able to load articles of different sizes, but also of different types: closed cardboard box, open crate, precut crate, tub, etc.

Palletizing systems capable of processing different formats are known. To allow a high degree of versatility, the fittings, and in particular the gripper, take up a large amount of space. These fittings are not usable in confined environments, where the space available for palletization is small. In this kind of environment, the movements are of the robot are limited, and increasingly restricted in terms of range as palletization continues. A fitting that requires a large amount of space cannot carry out palletization optimally.

Grippers that take up a less space are also known, for example grippers of the suction cup type. However, these grippers are much less versatile and cannot grasp articles of all kinds, such as an open crate, for example. Furthermore, moving the article only from above is not very reliable: if the cardboard box is of low quality, it may deform or even tear while it is being grasped and moved, in particular if it is heavy.

In the field of the invention, it is therefore necessary to develop a solution that makes it possible to simplify the setting down of articles on a pallet, by giving the gripping device itself a large range of movement.

The present invention provides a gripping device for a palletizing system that makes it possible to overcome all the conventional constraints associated with this type of equipment. It provides, in particular, a gripping device that is very versatile and takes up little space, which comprises a support and a guide means on which two jaws that face one another are mounted, the two jaws being movable along the guide means.

The gripping device makes it possible, for example, to grasp one or more articles referenced in position on one side of a feed conveyor. The gripping device according to the invention makes it possible to keep the body in line with the palletizing robot, this being particularly advantageous in the case of confined environments, in particular for secure palletizing systems. Specifically, the movements of the body of the gripping device and of the jaws can be managed independently, and the device is thus not impeded by the environment, for example by a curtain or a safety partition.

Moreover, the gripping device according to the invention makes it possible to set down the articles on the edges of a pallet without overhanging the gripping device after having moved the articles that are still held on one side of said gripping device. Specifically, the dimensions and the operation of the gripping device allow it to have not only sufficient spacing of the jaws for it to be possible to load articles of any type and any size but also allow it not to interfere with a confined environment, within which the ranges of movement of a palletizing robot may be limited.

As a result, even though the gripping device has suitable dimensions for loading very bulky articles, it also needs to be able to load articles of small size. In this case, its dimensions may be problematic during unloading, on account of the degree of filling of the pallet, or on account of the structure of the palletizing system. However, the movement of the jaws along the guide means allows the device to set down the articles on the edges of a pallet without overhanging its body.

The movability of the two jaws of the gripping device therefore allows a high degree of versatility of use, whether this relates to the number of articles to be grasped, the nature thereof, or the dimensions thereof. Such a device can also be adapted to completely closed palletizing systems, in which the palletizing robot has limited freedom of movement.

### SUMMARY OF THE INVENTION

In the field of the invention, it is therefore necessary to develop a device that is compact, versatile and reliable, allowing the loading, transport and unloading of articles of varied dimensions and type (closed cardboard box, open crate, etc.), specifically in a system of restricted size.

The invention thus aims to provide a gripping device to be mounted on a robot for a palletizing system, for loading, transporting and unloading articles of the box or crate type, said device comprising a support for fastening to said robot, and a guide means mounted on said support.

The device according to the invention is characterized in that it comprises at least two jaws that face one another and are mounted movably on said guide means, for clasping the sides of at least one article with said support above said at least one article, and an actuating means for moving said jaws independently of one another along said guide means between a spaced-apart position of said jaws and a clasping position.

According to an additional feature, the guide means is a linear guide.

In certain embodiments, the jaws of the gripping device are plates.

According to a possible additional feature, the jaws are plates and at least one plate extends under the support of the device and is orthogonal to the guiding direction.

In certain embodiments, the jaws are plates and at least one plate is oriented at an angle of around five to fifteen degrees, the distal ends of the plates being closer together than the proximal ends. The fact that at least one plate is oriented makes it possible to adjust the clamping force during the picking up of at least one article.

Advantageously, at least one of the jaws is a flexible plate, preferably in the form of a plurality of flexible slats. The use of flexible slates makes it possible both to adjust the clamping force and to adapt to variations in dimensions of the articles to be grasped.

In certain embodiments, the actuating means comprises, for at least one jaw, a control module comprising:
a movable member which is mounted on the guide means and to which the corresponding jaw is fastened,
a belt to which said member is fastened, and
a motor for driving said belt.

In certain embodiments, the actuating means comprises, for at least one jaw, a control module comprising:
a movable member which is mounted on the guide means and to which the corresponding jaw is fastened, and
a linear motor for driving said movable member.

According to a possible additional feature, at least one control module comprises a force detector for controlling the movement of at least one jaw on the basis of the force measured, in particular the movement of the jaw in the form of a plate having flexible slats, where appropriate.

A further subject of the invention is a system for loading, transporting and unloading articles, having a pick-up zone for loading at least one article, and a set-down zone for unloading said articles. The system comprises at least one feed conveyor for feeding said articles, said at least one feed conveyor leading into the pick-up zone.

The system is characterized in that it comprises at least one gripping device as described above, said at least one device being coupled to a robot via a pairing means mounted on the support of said device, said robot moving said at least one device.

A further subject of the invention is a palletizing process using such a device, comprising, for a palletizing cycle, at least the following steps of:
loading at least one article in a pick-up zone, said loading comprising the positioning of said device, the support of said device being positioned beneath said at least one article, and said loading comprising the moving of at least one of said jaws along a guide means in order to clasp the sides of said at least one article,
transporting said at least one article clasped by said device from said pick-up zone to a set-down zone via said robot,
unloading said at least one article onto a pallet in said set-down zone by moving said jaws away from one another along said guide means.

According to a possible additional feature, while at least one of the steps of the palletizing process is being carried out, the two jaws move along the guide means while keeping at least one article clasped by the gripping device.

In possible embodiments, at least two different positions of the jaws with respect to the support of the device are indexed for two successive palletizing cycles.

According to a possible additional feature, during the step of loading an article, a first jaw, referred to as the reference jaw, is fixed along the guide means, while a second jaw, referred to as the clamping jaw, moves along the guide means in order to clasp said at least one article.

In certain embodiments, the clamping force of the jaws is adjusted during the loading of at least one article.

### BRIEF DESCRIPTION OF THE FIGURES

The invention will be understood better from the following description, which is based on possible embodiments, which are explained in an illustrative and entirely nonlimiting manner, with reference to the appended figures, in which:

FIG. 1 schematically shows a perspective view of one embodiment of the gripping device;

FIG. 2 schematically shows a side view of a gripping device fitted to the end of a robot in the form of a robot arm;

FIG. 3 schematically shows a simplified top view of a system equipped with a gripping device, during a first step of loading an article from a pick-up zone, showing in particular the movement of the jaws with respect to one another so as to clasp said articles at the sides thereof;

FIG. 4 schematically shows a side view of a system equipped with a gripping device, showing a step of setting down said article by transporting said device via the movement of the robot arm;

FIG. 5 schematically shows a view similar to FIG. 4, during a step of setting down another article, showing in particular the movement of the jaws combined with the movement of the robot arm.

### DETAILED DESCRIPTION

In the rest of the description, elements having an identical structure or similar functions will be denoted by one and the same reference.

A palletizing system comprises a palletizing robot 2 on which a gripping device 1 is mounted.

The robot 2, which may be in the form of a robot arm, transports the device 1 from one position to another, whether or not the device 1 is loaded. While the robot 2 provides the movement functions, the gripping device 1 carries out the actions of loading and unloading articles 3 of the box or crate type.

As will be described in detail below, the gripping device 1 may also execute the movement of one or more clasped articles 3 without the robot 2 having to carry out an additional movement.

Loading is carried out by the gripping device 1, which will grasp an article 3 in a pick-up zone 10. After transporting the grasped article 3, via the movement of the robot 2, the device 1 releases said article 3 onto a pallet 100 situated in a set-down zone 11.

According to the invention, and to carry out the different movements, the gripping device 1 comprises a support 5 allowing it to be fastened to a palletizing robot 2 via a pairing means 9.

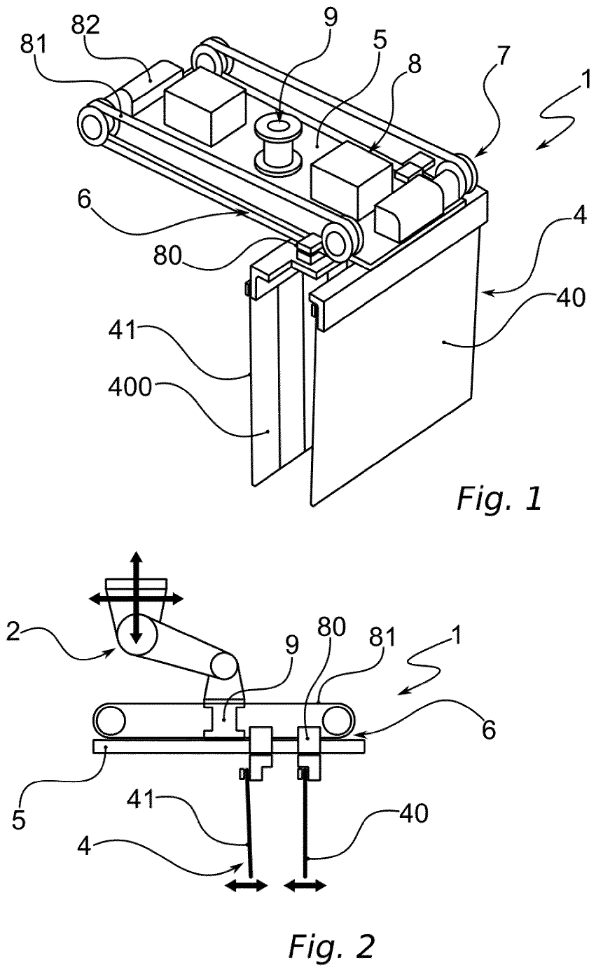

The gripping device 1 comprises two jaws 4 that face one another and are mounted movably on a guide means 6, said guide means 6 being mounted on the support 5. One possible embodiment of such a gripping device 1 can be seen in FIG. 1.

Advantageously, during a step of loading at least one article 3, at least one of the two jaws 4 moves along the guide means 6 in order to clasp the sides of at least one article 3. During this step, the support 5 is situated above said at least one article 3 to be grasped. The gripping device 1 also comprises an actuating means 7 which makes it possible to move said jaws 4 independently of one another along the guide means 6 between a spaced-apart position of said jaws 4 and a clasping position. Preferably, the actuating means 7 is mounted on the support 5.

In certain embodiments, and as will be described below, the actuating means 7 comprises, for each jaw 4, a control module 8, said control module 8 being able to be mechanical and/or magnetic.

In certain embodiments, the actuating means 7 comprises a force detector.

The jaws 4 move longitudinally in the plane of the guide means 6 fastened to the support 5, in a guiding direction. Preferably, the jaws 4 move horizontally along said guide means 6.

This allows each jaw 4 to move independently from one side of the gripping device 1 to the other, said device 1 thus being much more versatile and having greater freedom of movement, all the more so when the pallet 100 in the set-down zone 11 reaches a high filling level. Specifically, not only does the gripping device 1 allow the clasping, that is to say the grasping, of one or more articles 3 at their sides, but also the movement of said one or more articles 3 from one side of the gripping device 1 to the other. Thus, while the movements and the range of movement of the robot 2 may be constrained by the structure of the palletizing system, or even more or less limited depending on the degree of filling of the pallet, the article or articles 3 clasped by the jaws 4 can be moved from one side of the gripping device 1 to the other. This therefore allows the device 1 to be positioned at a location that is accessible to or more easily accessible by the robot 2, while allowing one or more articles 3 to be unloaded at the desired position.

The invention therefore allows two types of movement of the loaded articles 3, a movement generated by the robot 2, and a movement generated by the jaws 4.

It will be understood that the jaws 4 of the gripping device 1 can be positioned prior to the loading of one or more articles 3 on one side of the guide means 6 or the other, depending on the movements to be subsequently carried out via the robot 2 in order to transport and then unload said one or more articles 3 in the set-down zone 11. Furthermore, once the gripping device 1 is situated in the set-down zone 11, said one or more articles 3 can still be moved, while remaining held by the jaws 4, along the guide means 6 before being unloaded by said gripping device 1. These movements of the jaws 4 are also conceivable during the step of transporting at least one article 3, grasped and held by the gripping device 1, from a pick-up zone 10 to a set-down zone 11.

Therefore, it is possible, for example, to position the gripping device 1 without requiring excessively sophisticated movements, which may extend the duration of the palletizing cycles, or a large range of the robot 2, the movability of the jaws 4 allowing the device 1 to unload the articles 3 at the desired position. For example, it is possible to position the gripping device 1 above the pallet 100, without overhanging it, and then to unload one or more articles 3 at any location on the pallet, in particular at the edges of said pallet in an optimal manner, without moving the device 1 again.

The gripping device 1 is therefore very versatile and benefits from a large range of action, which does not depend only on the one position of the gripping device 1. This is particularly useful when the palletizing robot 2 carries out the movements in a restricted space.

The movement of the jaws 4 along the guide means 6 also makes it easier for the robot to access the extreme set-down points. An extreme set-down point is, for example, a rim of the pallet that is farthest away from said robot.

It is easy to see the numerous advantages associated with the invention and its great capacity to move the articles 3 to be loaded, transported and unloaded, the different movements being carried out not only by a palletizing robot 2 but also by the gripping device 1 itself.

According to a possible additional feature, the guide means 6 is a linear guide rail.

The clasping position corresponds to a position in which the jaws 4 hold the article or articles 3 in order to allow them to be loaded or transported before being unloaded. The articles 3 can then be transported, in a raised manner, from a pick-up zone 10 to the set-down zone 11. The gripping device 1 will thus, for example, pick up one or more articles 3 directly from one or more feed conveyors 15. Thus, in certain embodiments, a stream of articles 3 is fed by at least one feed conveyor which passes into the pick-up zone.

The spaced-apart position corresponds to a preparation position of said jaws 4 prior to a loading step and/or to a position in which the jaws 4 unload one or more articles 3 onto a pallet in the set-down zone 11.

As can be seen in FIG. 1, in certain embodiments, the jaws 4 of the gripping device 1 are plates 40. Said plates 40 extend under the support 5 and have the advantage of ensuring clamping uniformity.

A “plate” is understood to be a jaw 4 which has a flat surface, of small thickness, and which extends under the support 5. In any event, the thickness of a plate 40 is small compared with its width.

In possible embodiments, the thickness of a plate 40 is around 2 to 10 millimeters (mm) for a width of said plate 40 of between 200 and 600 mm.

According to an additional feature, at least one jaw 4 is in the form of a plate 40, said first plate 40 extending under the support 5 and being orthogonal to the guiding direction.

In certain embodiments, at least one jaw 4 is in the form of a plate 40, said plate 40 extending under the support 5 and being oriented at an angle of around five to fifteen degrees, preferably five degrees, the distal ends of the jaws 4 being closer together than the proximal ends.

In a preferred embodiment, the jaws 4 are plates 40 extending under the support 5, one plate 40 being orthogonal to the guiding direction and the other plate 41 being oriented in the direction of the plate 40 at an angle of around five to fifteen degrees, preferably five degrees, and the distal ends of the jaws 4 being closer together than the proximal ends. In other words, the oriented plate 41 converges vertically from top to bottom in the direction of the other plate 40, when the plates 40, 41 extend under the support 5.

Advantageously, this makes it possible to adjust the clamping force during the loading of the packages, making it possible to keep a large contact surface between the oriented plate 41 and the article or articles 3 being loaded. In particular, this makes it possible to adjust the clamping force while keeping a large contact surface with the article 3 by virtue of the flexing of the plate 41 which is oriented before clamping. The higher the clamping force, the more the oriented plate 41 will flex until it becomes orthogonal to the guiding direction. The surface in contact with the side 20 of the article 3 will be at a maximum, and this will ensure the best hold of the heaviest articles 3.

In certain embodiments, at least one of the jaws 4 is a flexible plate 40, preferably in the form of a plurality of flexible slats 400. A jaw 4 in the form of a flexible plate 40 is particularly advantageous. Specifically, this allows the gripping device 1 to pick up one or more packages or articles 3 at the same time, the packages being able to have dimensions that are not identical. The flexible plate 40 will deform under the effect of the clamping. This therefore further increases the versatility of the gripping device 1. This also makes it possible to optimally control the clamping force of the gripping device 1.

In certain embodiments, at least one jaw 4 is a flexible plate 40 in the form of a plurality of flexible slats 400. The flexible slats 400 are made, for example, of carbon fiber, or of high-strength steel plate.

Advantageously, the flexible slats make it possible to better control the pushing force, and to apply it precisely to the article or articles 3 to be grasped. In particular, the gripping device 1 may grasp a plurality of articles 3 at the same time, said articles 3 having slightly different dimensions. This variability is associated, for example, with the manufacturing tolerances of the packages, or with shaping defects. In this case, there are discrepancies between the articles 3 to be grasped at the same time. The use of at least one jaw 4 in the form of a flexible plate 40 provided with a plurality of slats 400 thus makes it possible to ensure proper gripping of all the articles 3, the independence of each slat 400 making it possible to follow the discrepancies between the articles 3. Thus, a sufficient contact surface is obtained between each slat 400 of the flexible plate 40 and a side 20 of the articles 3 to be loaded.

Preferably, the at least one of the plates 40, 41 that is oriented at an angle of around five to fifteen degrees is a flexible plate 40, 41. The flexibility of a plate 40, 41 contributes to changing the force applied while grasping one or more articles.

In possible embodiments, a first jaw 4 is in the form of a flexible plate 40 in the form of a plurality of flexible slats 400, said plate 40 being oriented at an angle of around five to fifteen degrees, and a second jaw 4 is in the form of a rigid plate 41. A rigid plate 41 is understood to be a plate, the deformation of which remains low under the clamping force.

The use of at least one jaw 4 in the form of a rigid plate 40, 41 makes it possible to keep the grasped article 3 in position and makes it easier to set down said article 3 on a pallet 100.

According to a possible additional feature, which can be seen in FIG. 1, the actuating means 7 comprises, for each jaw 4, a control module 8 formed of a movable member 80 which is mounted on the guide means 6 and to which the corresponding jaw 4 is fastened, of a belt 81 to which said member 80 is fastened, and of a motor 82 for driving said belt 81. This possible embodiment advantageously makes it possible to independently move each jaw 4 reliably and easily.

Preferably, the motor 82 is a servomotor. This embodiment allows controlled clamping of the packages by virtue of the limitation of the clamping torque allowed by the motors, while having a small space requirement, in contrast to clamping by way of pneumatic cylinders. The applied force is thus measured by the controller of the servomotor.

According to a variant, the actuating means 7 comprises, for each jaw 4, a control module 8 formed of a movable member 80 which is mounted on the guide means 6 and to which the corresponding jaw 4 is fastened, and of a linear motor for driving said movable member 80.

In certain embodiments, the control module 8 can therefore be a mechanical and/or magnetic control module 8.

In certain embodiments, the gripping device 1 comprises a force detector for controlling the movement of at least one jaw 4 on the basis of the force measured.

According to a possible additional feature, the force detector is comprised in the at least one control module 8 in order to more optimally control the movement of at least one jaw 4 on the basis of the force measured.

This is particularly advantageous for controlling the movement of the jaw 4 when it is in the form of a flexible plate 40, preferably in the form of a plurality of flexible slats 400.

Specifically, the use of a jaw 4 in the form of a flexible plate 40 advantageously makes it possible to grasp a group of articles 3 with non-identical dimensions. In this case, it is necessary to adjust the clamping force to the dimensions of the article 3 or of the group of articles 3, but also to the rigidity or to its weight, in order to ensure reliable loading of the articles 3.

The invention also relates to a system for loading, transporting and unloading articles 3, having a pick-up zone 10 and a set-down zone 11. The palletizing system may also comprise a feed conveyor 15 for feeding the articles 3 to be palletized, said feed conveyor 15 leading into the pick-up zone 10.

The invention also relates to a gripping device 1 as described above, said gripping device 1 being coupled to a robot 2, such as a robot arm, via a pairing means 9 mounted on the support 5 of said device 1. The robot 2 allows the gripping device 1 to move between the pick-up zone 10 and the set-down zone 11, in order to palletize articles 3.

Lastly, the invention relates to a palletizing process using a gripping device 1 as described above.

The process comprises, for a palletizing cycle, a step of loading at least one article 3 by means of the gripping device 1 in a pick-up zone 10.

The loading step comprises a first phase of positioning the device 1, the support 5 of the device 1 being placed above said at least one article 3. The positioning step optionally comprises a step of moving at least one jaw 4 along the guide means 6.

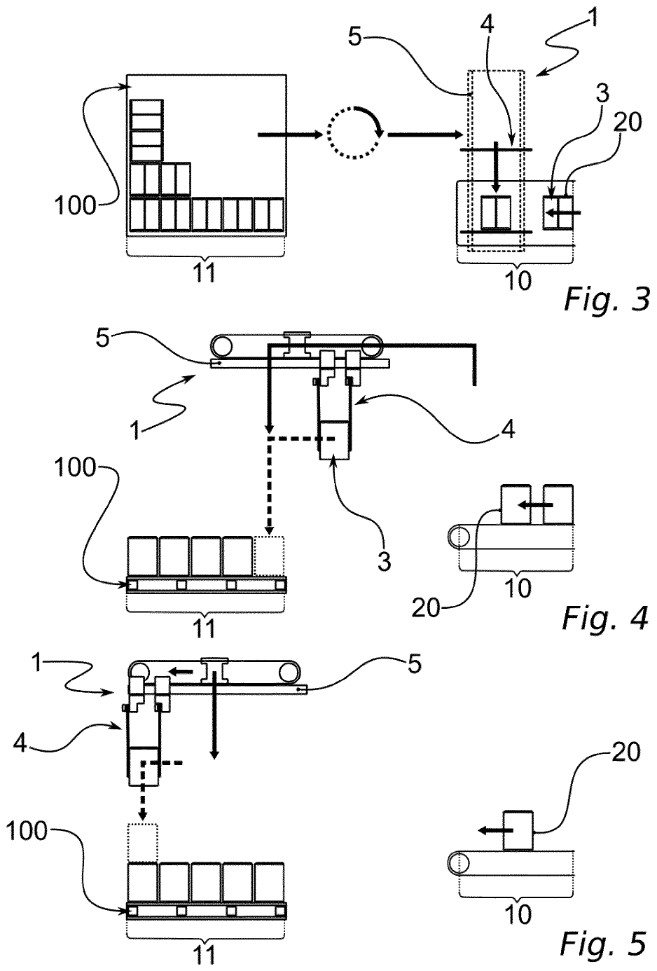

The step of loading at least one article 3, which can be seen in a top view in FIG. 3, comprises a second phase during which at least one of the jaws 4 is moved along the guide means 6 in order to clasp the sides 20 of said at least one article 3. The jaws 4 therefore pass from a spaced-apart position to a clasping position.

At the end of the loading step, at least one article 3 is therefore loaded, that is to say held at its sides 20, clasped, by the jaws 4 of the gripping device 1.

The process also comprises a step of transporting said at least one loaded article 3, from the pick-up zone 10 to a set-down zone 11, the transport being carried out by the robot 2 to which the gripping device 1 is fastened. This step can be seen in FIG. 4, which shows the movement of the gripping device 1 toward the set-down zone 11.

The process also comprises a step of unloading said at least one grasped article 3 onto a pallet 100 in the set-down zone 11. This unloading step is carried out by moving the jaws 4 away from one another along the guide means 6.

For example, the unloading step can be carried out by moving at least one of the jaws 4 of the device 1 along the guide means 6 in order to pass from a clasping position to a spaced-apart position, the at least one jaw 4 moving away from the other jaw 4.

This movement of the two jaws 4 away from one another may, for example, by carried out by the movement of one jaw 4 or by the movement of both jaws 4, each one passing on one side or the other of the guide means 6, or each of the jaws 4 passing in the same direction along the guide means 6 but at different speeds. FIG. 2 shows a side view of a gripping device 1 fitted to the end of a robot arm, wherein the possible movements of the jaws 4 are illustrated by arrows.

The passage from the clasping position to the spaced-apart position is carried out by the movement of at least one jaw 4 along the guide means 6, said at least one jaw 4 moving away from the at least one clasped article 3. This passage between a clasping position and a spaced-apart position can also be effected via the simultaneous movement of the two jaws 4 in opposite directions, or via the movement of the two jaws 4 in the same direction but at different speeds.

Preferably, during the unloading step, and in particular when articles 3 are already situated on the pallet 100, a first jaw 4 is positioned against the side 20 of an article 3 on the pallet 100, and a second jaw 4 moves away from the clasped article 3 in order to release it and unload it onto said pallet 100. In other words, one jaw 4 moves along the guide means 6 in order to unload the grasped article or articles 3.

In possible embodiments, during the unloading step, the two jaws 4 move along the guide means 6 and the robot 2 accompanies the movement of one of the jaws 4 in order that the position of said jaw 4 does not vary. This is particularly useful when articles 3 have already been unloaded onto the pallet 100. Thus, the movement of the jaws 4 will not bring about the movement or dropping of the articles 3 that are already present on said pallet 100.

According to a possible additional feature, before, during or at the end of the execution of at least one of the steps of the process, the two jaws 4 move along the guide means 6 while keeping the at least one article 3 clasped.

To this end, the two jaws 4 may move jointly along the guide means 6, in the same direction and at the same speed.

In particular, before or during the transport step, or even at the end of this step, the at least one grasped article 3 may be moved along the guide means 6 on one side of the gripping device 1 or the other by the movement of said jaws 4. This is particularly advantageous when the robot 2 has to move in a restricted space. Specifically, the robot 2 can place the device 1, in several successive cycles, in the same position, or in a position that is easy for said robot 2 to access, while the gripping device 1 will complete the proper positioning of the at least one article 3 to be unloaded, via the movement of said at least one article 3 to be clasped along the guide means 6. The proper execution of the palletizing steps is therefore ensured, by virtue of the features of the gripping device 1.

FIG. 5 shows a step of unloading an article 3, wherein, simultaneously with the transport of said article 3, the jaws 4 move along the guide means 6 while remaining in the clasping position, in order to allow optimal positioning of the article 3 before it is unloaded.

In certain embodiments, for two successive palletizing cycles, at least two different positions of the jaws 4 with respect to the support 5 of the device 1 are indexed.

The indexing corresponds to the recording of the position of the jaws 4 during each palletizing cycle. This recording can be effected with the aid of position sensors, the positions optionally being transmitted to a control unit. Thus, the recording of the position of the jaws 4 during the unloading of the article makes it possible to optimize the positioning of the device 1 during the following cycle. This is particular advantageous when the pallet 100 is almost completely filled and the freedom of movement of the gripping device 1 is even more limited. It is, in particular, possible to place the gripping device 1 in the same position in several successive cycles, by taking into account the indexed positions, in order to ensure proper unloading of the at least one loaded article 3 onto the pallet 100.

According to a possible additional feature, during the step of loading at least one article 3, a first jaw 4, referred to as the reference jaw, is fixed along the guide means 6, while a second jaw 4, referred to as the clamping jaw, moves along the guide means 6 in order to clasp said at least one article 3. Thus, the passage from a spaced-apart position to a clasping position is realized by the movement of just one of said jaws 4.

According to a possible additional feature, when the passage from a spaced-apart position to a clasping position during the loading of at least one article 3 is realized by the movement of just one jaw 4, the clamping force of said jaws 4 is adjusted.

The gripping device 1 according to the invention therefore advantageously makes it possible to load, transport and unload one or more articles 3 reliably. Moreover, the device 1 is versatile, and makes it possible not only to load articles 3 of different types and/or dimensions, but also to adapt to restricted spaces.

Although the above description is based on particular embodiments, it has no limiting effect on the scope of the invention, and modifications can be made, in particular by substituting equivalent techniques or by combining in a different way all or some of the features set out above.

1. A gripping device to be mounted on a robot for a palletizing system, for loading, transporting and unloading articles of the box or crate type, the gripping device comprising:
a support for fastening to the robot;
a guide means mounted on the support;
at least two jaws that face one another and are mounted movably on the guide means, configured to clasp the sides of at least one article with the support above the at least one article; and
an actuating means for moving the jaws independently of one another along the guide means between a spaced-apart position of the jaws and a clasping position.

2. The gripping device as claimed in claim 1, wherein the guide means is a linear guide.

3. The gripping device as claimed in claim 1, wherein the jaws are plates.

4. The gripping device as claimed in claim 3, wherein at least one plate extends under the support and is orthogonal to the guiding direction.

5. The gripping device as claimed in claim 3, wherein at least one plate is oriented at an angle of around five degrees to fifteen degrees, the distal ends of the plates being closer together than the proximal ends.

6. The gripping device as claimed in claim 1, wherein at least one of the jaws is a flexible plate, in the form of a plurality of flexible slats.

7. The gripping device as claimed claim 1, wherein the actuating means comprises, for at least one jaw, a control module comprising:
a movable member which is mounted on the guide means and to which the corresponding jaw is fastened;
a belt to which the member is fastened; and
a motor for driving the belt.

8. The gripping device as claimed in claim 1, wherein the actuating means comprises, for at least one jaw, a control module comprising:
a movable member which is mounted on the guide means and to which the corresponding jaw is fastened; and
a linear motor for driving the movable member.

9. The gripping device as claimed in claim 8, wherein at least one control module comprises a force detector for controlling movement of at least one jaw on the basis of the force measured.

10. A system for loading, transporting and unloading articles, comprising:
a pick-up zone for loading at least one article; and
a set-down zone for unloading the articles;
the system further comprising at least one feed conveyor for feeding the articles, the at least one feed conveyor leading into the pick-up zone,
wherein the system comprises at least one gripping device as claimed in claim 1, the at least one gripping device being coupled to a robot via a pairing means mounted on the support of the gripping device, the robot moving the at least one gripping device.

11. A palletizing process using a gripping device as claimed in claim 1, comprising, for a palletizing cycle, at least the following steps of:
loading at least one article in a pick-up zone, the loading comprising positioning of the gripping device, the support the gripping device being positioned beneath the at least one article, and the loading comprising the moving of at least one of the jaws along a guide means in order to clasp the sides of the at least one article;
transporting the at least one article clasped by the gripping device from the pick-up zone to a set-down zone via the robot;
unloading the at least one article onto a pallet in the set-down zone by moving the jaws away from one another along the guide means.

12. The palletizing process as claimed in claim 11, wherein, while at least one of the steps of the process is being carried out, the two jaws move along the guide means while keeping the at least one article clasped by the gripping device.

13. The palletizing process as claimed in claim 11, wherein at least two different positions of the jaws with respect to the support of the gripping device are indexed for two successive palletizing cycles.

14. The palletizing process as claimed in any one of claims 11, wherein, during the step of loading an article, a first jaw, is fixed along the guide means, while a second jaw moves along the guide means in order to clasp the at least one article.

15. The palletizing process as claimed in claim 11, wherein a clamping force of the jaws is adjusted during the loading of at least one article.

16. The gripping device as claimed in claim 9, wherein at least one of the jaws is a flexible plate in the form of a plurality of flexible slats.
